(19) United States
(12) Patent Application Publication
(10) Pub. No.: US 2008/0157996 A1
(43) Pub. Date: Jul. 3, 2008

(54) UNIVERSAL REMOTE CONTROLLER

(76) Inventors: Tain-Rein Chen, Hsinchu (TW); Daw-I Wang, Hsinchu (TW)

Correspondence Address: Rabin & Berdo, P.C.;Suite 500, 1101 14th Street, Washington, DC, 20005, US

(21) Appl. No.: 11/617,184

(22) Filed: Dec. 28, 2006

(51) Int. Cl. H04Q 1/00

(52) U.S. Cl. 340/825.22

(57) ABSTRACT

A universal remote controller is used to remotely control electronic devices and has a casing, a memory module, a control panel, an IR module and a wireless transmission module. The memory module is mounted in the casing and has a storage unit and at least one I/O interface. The storage unit stores digital image data of internal settings of the universal remote controller and communication protocol codes of electronic devices initialized with the remote controller. The control panel is mounted in and is exposed through the casing, has multiple control keys and is capable of generating control signals in response to specific control keys pressed. The wireless transmission module decodes and transforms digital data in the storage unit into television carrier signals and transmits the television carrier signals to a television when the universal remote controller is near the television.

### BACKGROUND OF THE INVENTION

1. Field of the Invention

The present invention relates to a universal remote controller, and more particularly to a universal remote controller that has wireless and infrared transmission capabilities to transmit control signals, audio signals and visual signals to electronic devices.

2. Description of Related Art

Today, most electronic devices can be conveniently controlled with dedicated remote controllers. Each manufacturer provides devices and dedicated remote controllers with a specific communication protocol. However, even the same type of devices and remote controllers manufactured by the same manufacturer may have different communication protocols between the electronic devices and the remote controllers. This means that one electronic device cannot be controlled by other remote controllers except the dedicated one.

To overcome the foregoing problem, universal remote controllers have been invented. Each universal remote controller comprises an infrared (IR) receiver, memory, a control panel and an IR transmitter and is capable of controlling more than one different kind of electronic device. The IR receiver is capable of receiving IR pulses. The memory is connected to the IR receiver. The control panel comprises multiple control keys and is capable of generating control signals in response to specific the control keys pressed. The IR transmitter transmits the control signals in an IR pulse. When a connection is established between the universal remote controller and an electronic device, the IR transmitter in the universal controller transmits an initial query signal in an IR pulse to the electronic device. The electronic device returns an initialization signal in an IR pulse including communication protocol codes of the electronic device, and the IR receiver in the universal controller receives the initialization signal. The communication protocol codes are then stored in the memory.

However, establishing the connection between the universal remote controller and an electronic device takes a few minutes. If many electronic devices are to be controlled with a universal remote controller, establishing the connection between the universal remote controller and the electronic devices will take a long time.

Additionally, some universal remote controllers further have liquid crystal displays (LCDs) to display internal settings of the universal remote controllers. However, LCDs are expensive to manufacture and are broken easily.

To overcome the shortcomings, the present invention provides a universal remote controller that has wireless and infrared transmission capabilities to transmit control signals, audio signals and visual signals to electronic devices to mitigate or obviate the aforementioned problems.

### SUMMARY OF THE INVENTION

The main objective of the invention is to provide a universal remote controller that has wireless and infrared transmission capabilities to transmit control signals, audio signals and visual signals to electronic devices.

A universal remote controller in accordance with the present invention remotely controls electronic devices and comprises a casing, a memory module, a control panel, an infrared (IR) module and a wireless transmission module. The memory module is mounted in the casing and comprises a storage unit and at least one input/output (I/O) interface. The storage unit holds digital image data of internal settings of the universal remote controller and the communication protocol codes of electronic devices to which the remote controller has been initialized. The at least one I/O interface is mounted in and is exposed through the casing, is connected to the storage unit and selectively connects to an external digital device. The control panel is mounted in and is exposed through the casing, comprises multiple control keys and is capable of generating control signals in response to specific control keys pressed. The IR module is connected to the control panel to transform the control signals to IR pulses and to transmit the IR pulses. The wireless transmission module is connected to the memory module and the control panel to decode and transform digital data stored in the storage unit to television carrier signals and to transmit the television carrier signals to a television when the universal remote controller is near the television.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a universal remote controller in accordance with the present invention.

### DETAILED DESCRIPTION OF PREFERRED EMBODIMENT

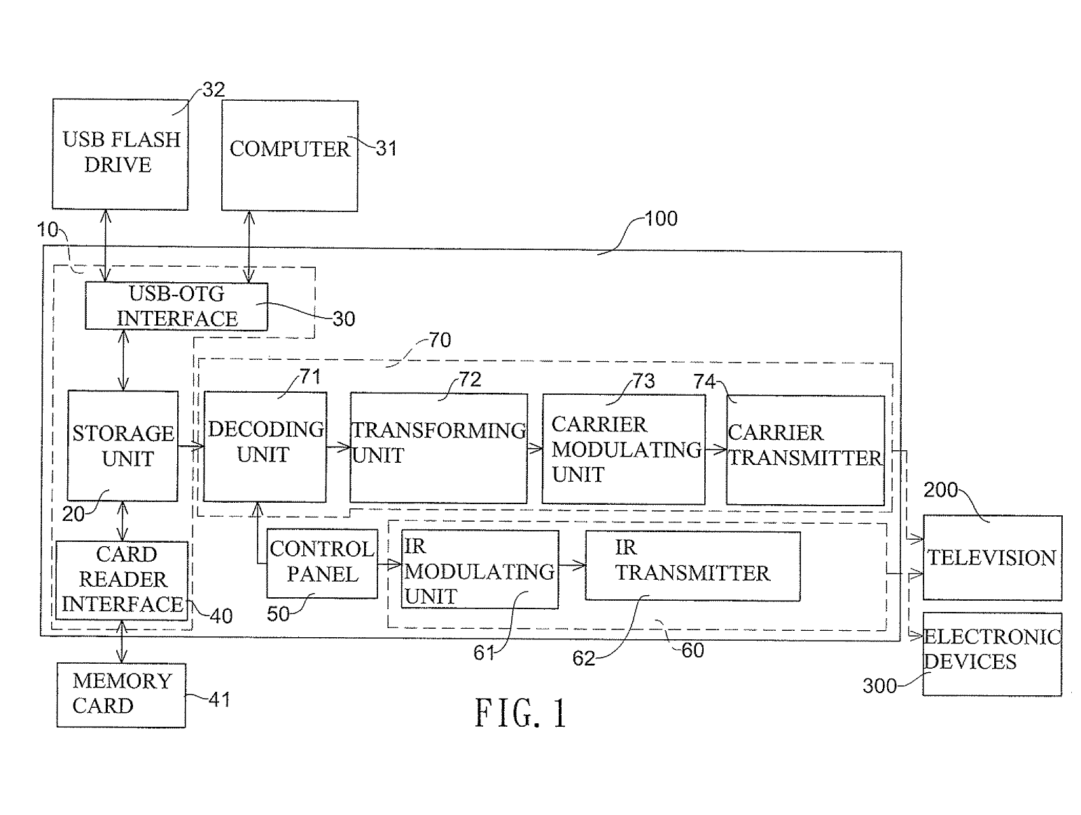

With reference to FIG. 1, a universal remote controller in accordance with the present invention is used to remotely control electronic devices (300), such as a television (200) having a tuner (201) and the like, and comprises a casing (100), a memory module (10), a control panel (50), an infrared (IR) module (60) and a wireless transmission module (70).

The memory module (10) is mounted in the casing (100) and comprises a storage unit (20) and at least one input/output (I/O) interface.

The storage unit (20) may be NAND flash memory and holds digital image data of internal settings of the universal remote controller and the communication protocol codes of the electronic devices (300) to which the remote controller has been initialized.

The at least one I/O interface is mounted in and is exposed through the casing (100), is connected to the storage unit (20), is capable of connecting to an external digital device and may be a universal serial bus (USB) interface, a card reader interface (40) or the both. The USB interface may be an USB-OTG (On-The-Go) interface (30). The USB-OTG interface (30) is capable of connecting to and exchanging digital data with a master USB device (such as a computer (31)) and a slave USB device (such as a USB flash drive (32)). The digital data may be the communication protocol codes of the electronic devices (300) to which the remote controller has been initialized, audio digital data or visual digital data, Additionally, the card reader interface (40) is capable of connecting to a memory card (41), such as a secure digital (SD) memory card, a multi media card (MMC) memory card or the like, to access digital data stored in the memory card (41).

The control panel (50) is mounted in and is exposed through the casing (100), comprises multiple control keys and is capable of generating control signals in response to specific control keys pressed.

The IR module (60) is connected to the control panel (50) to transform the control signals to IR pulses and transmit the IR pulses and may comprise an IR modulating unit (61) and an IR transmitter (62). The IR modulating unit (61) is mounted in the casing (100) and is connected to the control panel (50) to modulate and transform the control signals to IR pulses. The IR transmitter (62) is exposed through the casing (100) and is connected to the IR modulating unit (61) to transmit the IR pulses.

The wireless transmission module (70) is connected to the memory module (10) and the control panel (50) to decode and transform digital data stored in the storage unit (20) to television carrier signals and transmit the television carrier signals and may comprise a decoding unit (71), a transforming unit (72), a carrier modulating unit (73) and a carrier transmitter (74). When the universal remote controller is near the television (200), the television carrier signals will enter the television (200), and the tuner (201) in the television (200) will receive the television carrier signals. Therefore, the internal settings of the universal remote controller, the audio digital data and the visual digital data can be presented by the television (200).

The decoding unit (71) is mounted in the casing (100) and is connected to the storage unit (20) and the control panel (50) to decode digital data in the storage unit (20) and digital data from an external digital device. The digital data is the digital image data of the internal settings, audio digital data such as MPEG2 (Motion Picture Experts Group), Mpeg Layer 3 (MP3), Windows Media Audio (WMA) or the like or visual digital data such as Joint Photographic Experts Group (JPEG), motion-JPEG, MPEG4, H.264 or the like.

The transforming unit (72) is connected to the decoding unit (71) to transform the digital data decoded by the decoding unit (71) to television carrier signals.

The carrier modulating unit (73) is connected to the transforming unit (72) to modulate the television carrier signals.

The carrier transmitter (74) is connected to the carrier modulating unit (73) to transmit the modulated television carrier signals.

A universal remote controller as described has the following advantages.

First, the universal remote controller is a portable hand-held digital drive because the at least one I/O interface is capable of connecting to and exchanging digital data with a digital device, and the storage unit (20) is capable of storing the digital data.

Second, the universal remote controller can also serve as a media player because the wireless transmission module (70) is capable of decoding and transforming digital data to television carrier signals and transmitting the television carrier signals to the tuner (201) in a television (200) when the universal remote controller is near the television (200).

Third, the universal remote controller can transmits the internal settings of the universal remote controller in a display format to the television (200) with the wireless transmission module (70), and the internal settings are shown on the television (200). Therefore, the universal remote controller does not need a LCD like conventional universal remote controllers.

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terms in which the appended claims are expressed.

What is claimed is:

1. A universal remote controller being used to remotely control electronic devices and comprising:
a casing;
a memory module being mounted in the casing and comprising
a storage unit holding digital image data of internal settings of the universal remote controller and the communication protocol codes of the electronic devices to which the remote controller has been initialized; and
at least one input/output (I/O) interface being mounted in and being exposed through the casing, being connected to the storage unit and being capable of connecting to an external digital device;
a control panel being mounted in and being exposed through the casing, comprising multiple control keys and being capable of generating control signals in response to specific control keys pressed;
an infrared (IR) module connected to the control panel to transform the control signals to IR pulses and transmit the IR pulses; and
a wireless transmission module being connected to the memory module and the control panel to decode and transform digital data stored in the storage unit to television carrier signals and transmit the television carrier signals to a television when the universal remote controller is near the television.

2. The universal remote controller as claimed in claim 1, wherein the IR module comprises
an IR modulating unit mounted in the casing and connected to the control panel to modulate and transform the control signals to IR pulses; and
an IR transmitter exposed through the casing and connected to the IR modulating unit to transmit the IR pulses.

3. The universal remote controller as claimed in claim 1, wherein the wireless transmission module comprises
a decoding unit mounted in the casing and connected to the storage unit and the control panel to decode digital data in the storage unit and digital data from an external digital device;
a transforming unit connected to the decoding unit to transform the digital data decoded by the decoding unit to television carrier signals;
a carrier modulating unit connected to the transforming unit to modulate the television carrier signals; and
a carrier transmitter connected to the carrier modulating unit to transmit the modulated television carrier signals.

4. The universal remote controller as claimed in claim 1, wherein the I/O interface is a universal serial bus (USB) interface.

5. The universal remote controller as claimed in claim 1, wherein the I/O interface is a card reader interface.

6. The universal remote controller as claimed in claim 1 comprising two I/O interfaces, wherein
one I/O interface is a USB interface; and
the other I/O interface is a card reader interface.

7. The universal remote controller as claimed in claim 2, wherein the wireless transmission module comprises
a decoding unit mounted in the casing and connected to the storage unit and the control panel to decode digital data in the storage unit and digital data from an external digital device;
a transforming unit connected to the decoding unit to transform the digital data decoded by the decoding unit to television carrier signals;
a carrier modulating unit connected to the transforming unit to modulate the television carrier signals; and
a carrier transmitter connected to the carrier modulating unit to transmit the modulated television carrier signals.

8. The universal remote controller as claimed in claim 2, wherein the I/O interface is a USB interface.

9. The universal remote controller as claimed in claim 2, wherein the I/O interface is a card reader interface.

10. The universal remote controller as claimed in claim 2 comprising two I/O interfaces, wherein
one I/O interface is a USB interface; and
the other I/O interface is a card reader interface.

11. The universal remote controller as claimed in claim 3, wherein the I/O interface is a USB interface.

12. The universal remote controller as claimed in claim 3, wherein the I/O interface is a card reader interface.

13. The universal remote controller as claimed in claim 3 comprising two I/O interfaces, wherein
one I/O interface is a USB interface; and
the other I/O interface is a card reader interface.

14. The universal remote controller as claimed in claim 4, wherein the USB interface is an USB-OTG (On-The-Go) interface.

15. The universal remote controller as claimed in claim 7, wherein the USB interface is an USB-OTG interface.

16. The universal remote controller as claimed in claim 7, wherein the I/O interface is a card reader interface.

17. The universal remote controller as claimed in claim 7 comprising two I/O interfaces, wherein
one I/O interface is a USB interface; and
the other I/O interface is a card reader interface.

18. The universal remote controller as claimed in claim 8, wherein the USB interface is an USB-OTG interface.

19. The universal remote controller as claimed in claim 11, wherein the USB interface is an USB-OTG interface.

20. The universal remote controller as claimed in claim 15, wherein the I/O USB interface is an USB-OTG interface.
